(19) United States
(12) Patent Application Publication
(10) Pub. No.: US 2011/0049294 A1
(43) Pub. Date: Mar. 3, 2011

(54) Emergency Flotation Apparatus

(76) Inventors: Robert Morley, East Cowes (GB); James Nichols, East Cowes (GB); John Pritchard, East Cowes (GB)

(21) Appl. No.: 12/918,597

(22) PCT Filed: Feb. 20, 2009
(86) PCT No.: PCT/GB2009/000468

§ 371 Date: Nov. 18, 2010

(30) Foreign Application Priority Data
Feb. 22, 2008 (GB) 0803301.1

(51) Int. Cl. B64D 25/18; B64C 25/56; C06D 5/00

(52) U.S. Cl. 244/107; 102/530

(57) ABSTRACT

An emergency flotation device for an aircraft comprising a housing (9) containing an inflatable balloon (1) and a solid propellant cool gas generator (4) arranged to inflate the balloon when the aircraft ditches into water. The device is arranged so as to be optionally removable from the aircraft.

The present invention relates to an aircraft emergency flotation apparatus particularly, but not exclusively, for use on a helicopter.

### BACKGROUND

Various flotation systems are known in the art for maintaining the buoyancy of a helicopter which has been forced to land on water. It will be recognised that in an emergency landing on water it is essential to maintain at least a part of the helicopter fuselage above the water level so as to allow the occupants to evacuate the aircraft.

Generally, prior art flotation systems comprise either a buoyancy member attached to the aircraft fuselage or an inflatable buoyancy aid which can be inflated either manually or automatically on landing.

For example, U.S. Pat. No. 3,189,301 discloses an arrangement comprising a first flotation member connected to the rotor and a second flotation member arranged within the fuselage which in combination provide the aircraft with buoyancy on crash landing. More commonly modern aircraft are provided with inflatable bags or sacks which are coupled to compressed gas or air supplies within the aircraft via a control valve. The gas supply may for example be nitrogen, carbon dioxide or other suitable inert gas. Alternatively, an aspirator may be used to inflate a bag by drawing ambient air into the bag or bags. One example of such as system can be seen in U.S. 2007/0175378.

In the art a control valve is controlled by the pilot to inflate the system or by means of an immersion switch or the like arranged to activate the valve on contact with water. One such system is described for example in EP0193265 where the skids of a helicopter are provided with inflatable bags which are inflated on crash landing to support the helicopter on the surface of the water

There are however a number of significant drawbacks with currently available emergency flotation systems. For example, one significant problem with existing systems is the space which they accommodate both in and around the aircraft. This is particularly the case for larger aircraft where it is necessary to incorporate large buoyancy aids or inflatable bags to support the aircraft on ditching. The buoyancy aids and bags have to be carefully arranged and/or stored to minimise drag during normal flight whilst being suitably positioned to support the aircraft on inflation/deployment. In addition, systems employing inflatable bags require ancillary equipment such as pipe work extending between a gas supply to the inflatable bags as well as compressed gas tanks, compressors or the like. The additional weight of this equipment ultimately reduces the payload of the aircraft and the complexity and cost of the system to install and maintain.

In an attempt to address some of these drawbacks alternative gas supplies have been tested such as solid propellant gas generators. However, although gas generators can in some cases, at least in part, reduce the weight of an emergency inflation system the existing systems as a whole remain complex to install and maintain and are also limiting on the payload of aircraft.

Accordingly, an apparatus and method described herein seek to provide an emergency flotation system for an aircraft, and particularly a helicopter, which overcomes the problems with existing systems and which provides an emergency inflation system and method which can conveniently be employed on a range of aircraft.

### SUMMARY OF THE INVENTION

According to a first aspect of an invention disclosed herein there is provided an aircraft emergency inflation apparatus comprising at least one inflatable object and at least one cool gas generating device, wherein the gas generating device is arranged immediately adjacent to the inflatable object in an inflated and un-inflated state and is arranged to communicate generated gas directly into the inflatable object to inflate the object.

This provides an inflation apparatus which is substantially more comₚact than existing inflation devices. The gas generating device is arranged close to the un-inflated object (referred to as a balloon) so that the apparatus minimises the space consumed. Also, the gas generating device is arranged to exhaust gas directly into the balloon. The term ‘directly’ is intended to refer to the absence of an extended conduit or pipe as is used in conventional arrangements which communicate gas from a gas supply or generator (a compressor or aspirator) within the aircraft fuselage to the balloon or float. Similarly, this is intended to refer to a lack of any form of throttling valve, diffuser or the like which is arranged between the gas generator and the balloon to and which is found in conventional inflation systems. It follows that on inflation the gas generator is, in effect, supported by the inflated balloon.

Communicating gas directly from the gas generator to the balloon according to the present invention minimises the weight and complexity of the apparatus as well as the maintenance and installation costs. Gas may be introduced into the balloon at any suitable position according to the rolling or folding of the un-inflated balloon.

The generated gas passes out of the gas generator and into the balloon. The length of the passage of the gas from the outlet of the gas generator to the inlet of the balloon is advantageously as short as possible so as to minimise the inflation time and pressure loses and to minimise the overall size of the arrangement. This length can advantageously be minimised by virtue of the complete absence of a diffuser, valve or the like.

The gas generating device is advantageously a Solid Propellant Cool Gas Generator (SPCGG) of the type developed by TNO Prins Maurits Laboratory. Gas generators of this type allow gas to be generated at or around ambient temperature as opposed to conventional gas generators which generate gases at high temperatures. In the present application it is desirable to introduce cool gas into the inflatable balloons to prevent melting or softening of the elastomeric materials. The generators are formed of a solid block of material which chemically stores the gas as a solid. The gas may be any suitable inert gas for the present application such as carbon dioxide, nitrogen and so forth. The gas generator may be arranged to output gas at or below 100° C.

The gas generator selected for a particular aircraft flotation system is advantageously adapted so as to generate and release gas at a predetermined flow rate defined by the type of balloon being employed for the given aircraft. For large aircraft, large balloons or multiple small balloons must be used. Conversely, for small aircraft smaller balloons must be used.

It has been recognised by the present inventors that the gas flow rate into the balloons must be selected to be below a first rate which would cause a rapid build-up of pressure within the balloon. This could for example be caused by the balloon not being able to unfold quickly enough thereby restricting the flow of gas into the balloon as consequently increasing pressure. Conversely, the flow rate of gas into the balloons must as high as possible so that the aircraft is maintained above the water level as quickly as possible. If the inflation is too slow the aircraft will sink or become unstable.

Thus, the gas generator is configured to create gas below the first rate and as close to the highest rate as possible i.e. at a predetermined rate depending on the size and type of inflatable balloon. Adapting a cool gas generator may be achieved in a variety of ways for example by material selection or material porosity or the like. It will be recognised that the range of flow rates is entirely dependent on the specific balloon being employed in the apparatus and the size of the aperture between the gas generator and the balloon.

The present inventors have also established that it is desirable to maintain a substantially constant flow rate into the balloon over the inflation step to provide an even expansion and un-folding of the un-inflated balloon. Consequently, the cool gas generator is also adapted to provide a desired inflation time for a given balloon. In effect the apparatus employs a modified cool gas generator which is adapted in accordance with the parameters discussed above.

Advantageously for each balloon the gas generator is configured to discharge between 80% and 90% of discharge gas into the balloon within a time period of between 3 and 6 seconds of activation (at ambient temperature and irrespective of overall balloon size). Less that 80% of the discharge gas does not provide the necessary buoyancy and more than 90% is above the inflation necessary for neutral buoyancy. Similarly, too rapid a deployment (<3 seconds) would cause a violent and undesirable inflation of the apparatus and too slow an inflation (>6 seconds) causes the aircraft to sink before floating (the precise value depends on the inherent buoyancy of the aircraft).

Most advantageously, it has been established that approximately 88% of the discharged gas should be discharged into the balloon within approximately 4 seconds of activation. Discharging this percentage of gas within this predefined period of time achieves the required neutral buoyancy as quickly as possible. Neutral buoyancy refers to the overall buoyancy of the aircraft i.e. at neutral buoyancy the aircraft does not move. As the remaining 12% of gas is discharged this brings the aircraft to a fully floated position. Achieving neutral buoyancy within 4 seconds advantageously prevents the aircraft from submerging too far beneath the waterline.

Adapting the cool gas generator in accordance with the properties of the specific balloon being connected thereto advantageously removes the need for throttling valves, diffuser or the like which are conventionally used to control the gas being introduced into a balloon. Furthermore, locating the gas generator immediately adjacent to the balloon removes the need for conduits and pipes running into the aircraft fuselage.

Advantageously the cool gas generators are arranged to create gas at a temperature below 100° C. This ‘cool’ gas negates the need for a heat exchange arrangement thereby further simplifying the system. This also permits the outlet of the gas generator to be connected directly to the inlet of the balloon again reducing size, complexity and additional connections which may leak.

As discussed above the cool gas generator allows the source of inflation gas to be coupled directly to the un-inflated balloon. Thus, advantageously this provides a ‘stand-alone’ inflation unit or module which can be coupled to an aircraft at any suitable position. This modular arrangement means that the apparatus does not require lengthy conduits or pipe work to be added to the airframe to communicate gas to the balloons from a pressure vessel or the like.

The modular unit may advantageously be contained within a casing to protect the balloon and gas generator when in-situ on an aircraft or in storage. This additionally facilitates handling of the apparatus for a user. The casing may itself be provided with a cross-section or profile corresponding to that of the aircraft and/or with an aerodynamic form to minimise any drag the module has on the aircraft in use. The casing or housing may additionally be provided with an opening or detachable portion which allows for the inflation of the balloon.

The module may be coupled to the aircraft in any suitable way. Typically the position of the module will be determined by the aircraft manufacturer to ensure that the load paths passing from the balloons (in contact with water) apply to appropriate portions of the airframe. The coupling may advantageously be a releasable fitting which conveniently allows the module to be coupled and de-coupled to the aircraft. Thus, for flights where the inflation system is not needed the aircraft payload can be increased.

The gas generator may be activated using any suitable means. For example, the generator may be activated by a manually operated switch in the cock-pit of the aircraft. Communication may be by means of a conductive wire to the gas generating device or by means of a suitable, perhaps encoded, wireless connection thereby simplifying the process of installing the module on the aircraft. Alternatively, or additionally, the gas generator may be activated by a control signal from one or more water sensitive switches (referred to as saline or submersion switches) or the like arranged to indicate when the helicopter has landed in or on water. Such a switch may be located on the aircraft or on the module casing again to minimise the complexity of installing the apparatus. Each switch may be routed through the pilot control unit allowing the pilot to arm and disarm the inflation device or devices.

Viewed from another aspect there is provided a method of inflating an aircraft emergency inflation apparatus, the apparatus comprising at least one inflatable object and at least one gas generating device, wherein the gas generating device is arranged immediately adjacent to the inflatable object in an inflated and un-inflated state and is arranged to communicate generated gas directly into the inflatable object to inflate the object, said method comprising the steps of: receiving a signal indicating a required inflation, activating the gas generating device in response to said signal and communicating generated gas into the inflatable object.

Viewed from yet another aspect there is provided an emergency helicopter inflation apparatus comprising at least one inflatable balloon and a corresponding solid propellant cool gas generator arranged in use to communicate generated gas directly into a balloon.

Viewed from a still further aspect there is provided a releasable fitting emergency inflation device for fitting to a portion of an aircraft comprising a housing containing an inflatable balloon and a solid propellant cool gas generator arranged to communicate generated gas into said inflatable balloon on receipt of an activation signal, wherein the housing is provided with a fitting arrangement permitting the device to be coupled and de-coupled to an aircraft.

Viewed from yet another aspect there is provided an aircraft emergency inflation system comprising a plurality of inflation modules, each module comprising a housing containing an inflatable balloon and a solid propellant cool gas generator arranged to communicate generated gas directly into said inflatable balloon on receipt of an activation signal.

The present invention advantageously provides an emergency inflation system for an aircraft which is substantially lighter than existing systems, is more economical to operate and install and is simpler in operation thereby extending service life. It also removes the need for expensive, heavy and maintenance intensive gas bottles within the aircraft fuselage. In addition, the present invention provides flexibility for aircraft operators by allow the system to be conveniently and rapidly removed from the aircraft.

Although various aspects of inventions are set out in the accompanying independent and dependent claims, it should be recognised that other aspects of the invention include any suitable and advantageous combination of features from the independent claims in combination with the dependent claims as well as from the description. Aspects of the invention are not to be construed as being limited to the combinations set out in the accompanying claims.

### BRIEF DESCRIPTION OF THE DRAWINGS

Embodiments of the invention will now be described, by way of example only, with reference to the accompanying drawings in which:

FIG. 1 shows in cross-section an inflated balloon and cool gas generator mounted on a helicopter;

FIG. 2 shows a detailed view of the connection between a cool gas generator and a balloon;

FIG. 3A shows a side view of an un-inflated balloon and cool gas generator mounted to a skid of a helicopter;

FIG. 3B shows a cross-section through an inflation module; and

While the invention is susceptible to various modifications and alternative forms, specific embodiments are shown by way of example in the following figures and are described below in detail. It should be recognised that the figures and corresponding detailed description are not intended to limit any invention to the particular form disclosed but the invention covers all modifications, equivalents and alternatives falling within the spirit and scope of the present invention. In addition, it will be recognised that the invention as claimed may involved any suitable combination of claims and or features described herein.

### DETAILED DESCRIPTION

Embodiments of the invention will be described below with specific reference to an emergency flotation device coupled to a helicopter.

Solid Propellant Cool Gas Generators (SPCGG) provide advantages over conventional gas storage arrangements because of the size of conventional pressure vessels which are required to safely secure high pressure gases. This is particularly the case for the aviation industry where strict safety regulations are in place.

In a SPCGG, gas is created by decomposition of a particular solid material. The material is generally a solid block which chemically stores a required inert gas. The block is contained within a sealed vessel. On activation a small igniter within the vessel starts the decomposition of the material into the gas. Gas exits the vessels via an outlet port. Gas exits the vessel at a temperature of less than 100° C. with a purity in excess of 99%.

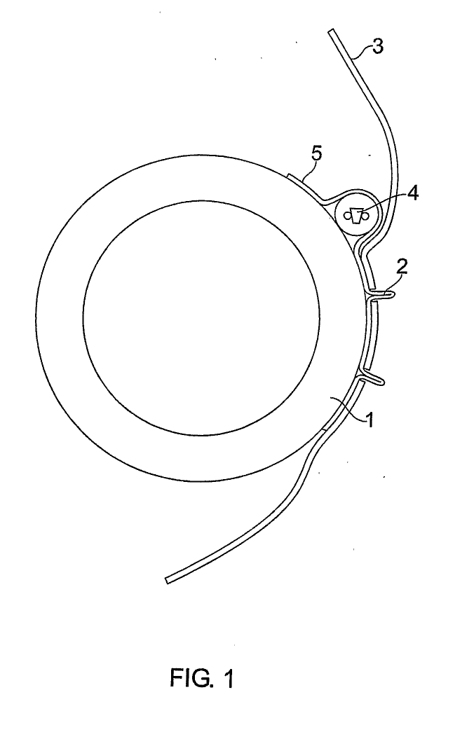

Turning to FIG. 1 there is shown in cross-section an inflated balloon and cool gas generator mounted on a helicopter. The inflated balloon 1 is bonded to a fixing bracket 2 which allows the balloon to be coupled to the skid 3 of a helicopter (FIG. 1 shows a reinforcing portion of the skid). A cool gas generator 4 of the type described above is connected by means of a strap 5 to the balloon. As shown the cool gas generator is arranged in contact with (i.e. immediately adjacent to) the balloon and this is the case both in an un-inflated condition and an inflated condition of the balloon 1. Only a portion of the skid 3 is shown.

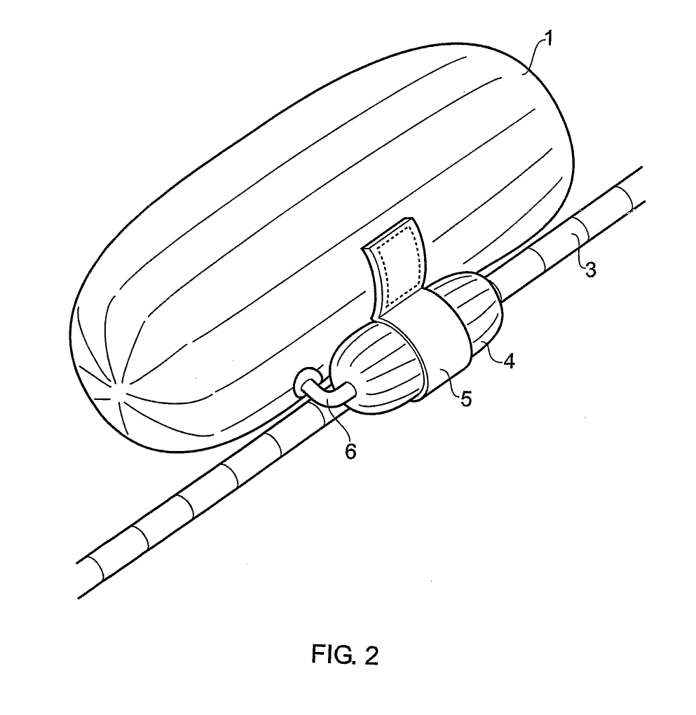

FIG. 2 shows a more detailed view of the connection between the cool gas generator and the balloon omitting for clarity the panel reinforcement portion of the helicopter skid 3. FIG. 2 shows the balloon 1 in an inflated state and the outlet 6 of the gas generator 4. As shown in FIG. 2 the outlet of the gas generator is coupled directly to the balloon i.e. there is no extended conduit, throttling valve or other gas handling component. The gas passes directly from the gas generator to the balloon. Also shown is the flexible connecting strap 5 extending around the gas generator 4 which allows the balloon to move as it is inflated. Because of the low operating temperature of gas generators of the type described herein it is possible to position the gas generator immediately against or close to the balloon without material damage. Consequently the two can be packaged close together in a modular form (discussed below) to minimise the size of the inflation system.

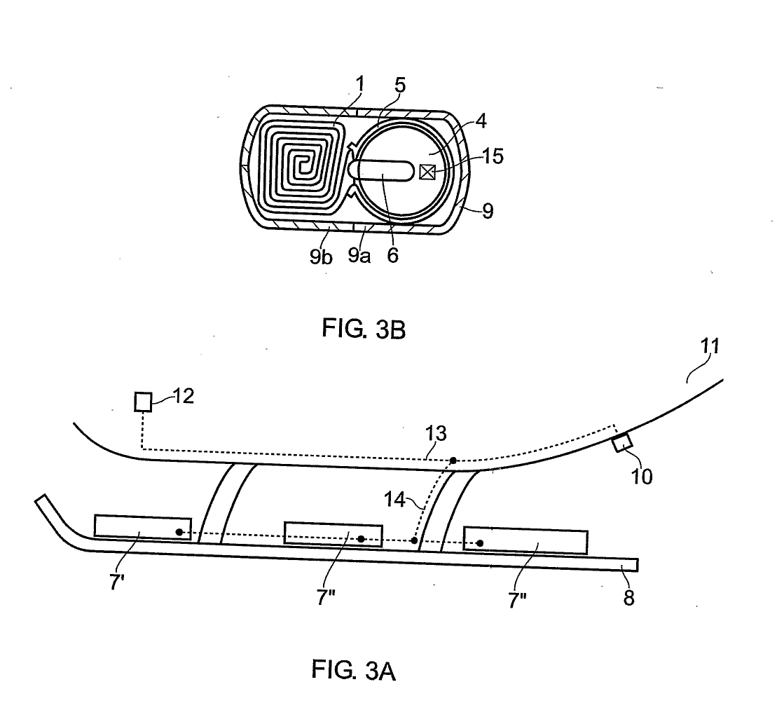

FIG. 3A shows a side view of an un-inflated balloon and cool gas generator mounted to a skid of a helicopter. As shown three modules 7′, 7″ and 7′″ are shown connected to an upper portion of a helicopter skid 8. The modules may be coupled to the skid by any suitable but releasable fitting means which sufficiently secures the floats to the aircraft. The modules may for example be coupled to the upper portion of the skid 8 through pre-formed holes in the skid surface by means of a quick release coupling allowing convenient and reliable positioning of the modules. Various suitable quick release couplings are known in the art which comply with aviation rules and regulations.

FIG. 3B shows a cross-section through part of a module. FIG. 3B shows the gas generator 4, gas outlet 6, connecting strap 5 and the balloon 1, here in an un-inflated condition. As shown the balloon is rolled and folded to minimise space consumed. The gas generator and balloon are contained within a module housing 9. The housing is formed of at least two parts 9a and 9b which in combination form the housing 9 which protects the apparatus and allows the apparatus to be easily handled. It also provides suitable connecting portions for aligning and connecting to the skid 8. In one embodiment one part of the housing, part 9a in this embodiment, is provided with an opening portion or a portion which disconnects or moves to allow the balloon to inflate out of the housing.

The modules (7′, 7″, 7′″) are positioned such that on inflation the helicopter remains stable and upright in the water.

FIG. 3A also shows an immersion sensor 10 which is located on the bottom of the fuselage 11. Immersion sensor 10 is arranged to provide a control signal when immersed in water. The cock-pit of the aircraft contains an additional manually operable switch 12 which provides a control signal when activated by the pilot.

Manual control switch 12 and the immersion switch 10 are both electrically connected to the wiring loom 13 of the aircraft. Similarly each of the modules (7′, 7″, 7′″) are each electrically connected to the wiring loom by connection 14. This allows a control signal to be communicated from the manual switch 12 or the immersion switch 10 via connection 14 to a control unit (reference 15 in FIG. 3A) on each gas generating device.

On contact with water or in response to a manual signal from control switch 12 a control signal is received by each control unit 15 of each module via communication path 14. On receipt of the signal the control unit ignites an igniter within the vessel of the gas generator. Gas is then created within each of the respective module gas generators and passes, via a respective outlet (reference 6) to a respective balloon. As the pressure increases the balloon inflates and expands pushing open the housing 9. Each gas generator is preconfigured to release approximately 88% of the available gas within 4 seconds of activation thereby bringing the aircraft to neutral buoyancy in the optimal time without an undesirable violent inflation. The gas continues to inflate each of the balloons until the balloons are fully inflated. This maintains the aircraft above the waterline and in a normal orientation permitting occupants to escape.

It will be recognised that the gas generator is adapted depending on the particular balloon which is to be inflated. The following parameters for the gas generator may be pre-determined for each installation:
volume of gas required (litres)
the output gas flow rate (litres/minute)
the output pressure from the gas generator
gas outlet temperature

These parameters are determined based on aircraft specific parameters including:
required balloon volume (litres)
required balloon material
maximum material operating temperature
inflation time (seconds)
maximum material rupture pressure

Consequently, it will be realised that the precise parameters for each gas generator will depend on the specific application and at least some of the parameters above.

Adapting a cool gas generator as described herein advantageously allows for an inflation system with a reduced size and consequently allows for a modular emergency flotation apparatus as described herein to be realised.

Although embodiments above have been described in considerable detail, numerous variations and modifications will become apparent to those skilled in the art with benefit of the teaching of the present disclosure.

1-30. (canceled)

31. An aircraft emergency inflation apparatus comprising at least one inflatable object and at least one solid propellant cool gas generating device arranged to generate gas having a temperature below 100° C. by exothermic decomposition of solid material contained within the cool gas generating device, wherein
the cool gas generating device is arranged immediately adjacent to the inflatable object in an inflated and an un-inflated state and arranged to communicate generated gas directly into the inflatable object to inflate the object,
the inflatable object is arranged only to receive gas from said cool gas generating device and to contain said gas; and
the emergency inflation apparatus further comprises at least one releasable coupling permitting the emergency inflation apparatus to be selectively and repeatedly coupled and decoupled to/from the aircraft.

32. An apparatus as claimed in claim 31, wherein the gas generator is arranged in use to provide a continuous gas flow rate to inflate the inflatable object.

33. An apparatus as claimed in claim 31, wherein the gas generator is arranged to inflate the inflatable object at a predetermined inflation pressure.

34. An apparatus as claimed in claim 31, wherein the gas generator is arranged to generate a predetermined mass of gas and to discharge between 80% and 90% of said predetermined mass of gas into the inflatable object within 3 to 6 seconds of activation.

35. An apparatus as claimed in claim 34, wherein 88% of said predetermined mass of gas is discharged into the inflatable object within 4 seconds of activation.

36. An apparatus as claimed in claim 31, wherein an outlet of the cool gas generating device is arranged to communicate generated gas directly to an inlet of the inflatable object.

37. An apparatus as claimed in claim 31, wherein the inflatable object and cool gas generating device are coupled together in a modular arrangement.

38. An apparatus as claimed in claim 37, wherein in an un-inflated condition, the inflatable object and cool gas generating device are contained within a casing surrounding the apparatus.

39. An apparatus as claimed in claim 38, wherein the casing is adapted to the aerodynamic properties of the portion of the aircraft to which the apparatus is coupled.

40. An apparatus as claimed in claim 31, wherein the gas generating device is arranged to receive an activating control signal causing the generation of gas.

41. An apparatus as claimed in claim 40, wherein the control signal is received from a submersion switch arranged on a lower portion of the aircraft.

42. An apparatus as claimed in claim 40, wherein the control signal is received from a manually operable activation switch within the aircraft.

43. An apparatus as claimed in claim 40, wherein the control signal is received from a submersion switch arranged on an exterior portion of the aircraft.

44. An apparatus as claimed in claim 31, wherein the inflatable object is in the form of an elongate inflatable balloon.

45. An aircraft emergency inflation system comprising a plurality of inflation modules, each module comprising the apparatus as claimed claim 31.

46. A vehicle comprising an apparatus as claimed in claim 31.

47. A vehicle of claim 46 in the form of a helicopter.

48. A method of inflating an aircraft emergency inflation apparatus, the apparatus comprising at least one inflatable object and at least one solid propellant cool gas generating device arranged to generate gas having a temperature below 100° C. by exothermic decomposition of solid material contained within the cool gas generating device, wherein
the cool gas generating device is arranged immediately adjacent to the inflatable object in an inflated and un-inflated state and is arranged to communicate generated gas directly into the inflatable object to inflate the object,
the inflatable object is arranged only to receive gas from said cool gas generating device and to contain said gas; and
the emergency inflation apparatus further comprises at least one releasable coupling permitting the emergency inflation apparatus to be selectively and repeatedly coupled and decoupled to/from an external portion of an aircraft,
said method comprising the steps of: receiving a signal indicating a required inflation, activating the cool gas generating device in response to said signal and communicating generated gas directly into the inflatable object.

49. A method as claimed in claim 48, wherein gas is generated to a predetermined pressure.

50. A method as claimed in claim 48, wherein gas is introduced into the inflatable object at a substantially constant mass flow rate.

51. A method as claimed in claim 48, wherein the gas generator generates a predetermined volume of gas and discharges between 80% and 90% of said predetermined volume of gas into the inflatable object within 3 to 6 seconds of activation.

52. A method as claimed in claim 51, wherein 88% of said predetermined volume of gas is discharged into the inflatable object within 4 seconds of activation.

53. An emergency helicopter inflation apparatus comprising at least one inflatable balloon and a corresponding solid propellant cool gas generator arranged in use to communicate generated gas directly into a balloon.

54. A releasable fitting emergency inflation device for fitting to a portion of an aircraft comprising a housing containing an inflatable balloon and a solid propellant cool gas generator arranged to communicate generated gas into said inflatable balloon on receipt of an activation signal, wherein the housing is provided with a fitting arrangement permitting the device to be coupled and de-coupled to/from an aircraft.

55. An aircraft emergency inflation system comprising a plurality of inflation modules, wherein each module comprises an apparatus according to claim 31.
